(19) United States
(12) Patent Application Publication
(10) Pub. No.: US 2017/0080438 A1
(43) Pub. Date: Mar. 23, 2017

(54) ASSEMBLY FOR PREPARING AND/OR PAINTING LARGE SURFACES

(71) Applicant: Ivan John STORR, Wooloowin (AU)

(72) Inventor: Ivan John STORR, Wooloowin (AU)

(21) Appl. No.: 15/269,568

(22) Filed: Sep. 19, 2016

(30) Foreign Application Priority Data
Sep. 19, 2015 (AU) 2015903830

(51) Int. Cl. B05B 3/00

(52) U.S. Cl. CPC B05B 3/00

(57) ABSTRACT

An assembly for preparing and/or painting large surface areas, such as building walls, includes a mounting device and a movable applicator. The mounting device provides a mechanism for positioning the movable applicator adjacent the wall surface, and allowing the movable applicator to move along the wall surface. The assembly can be mounted to a wall. The assembly preferably uses existing roof anchor points of the wall, for preparing and/or painting a large surface of the wall. In an alternative embodiment, the mounting means can move the movable applicator along the wall surface.

### CROSS-REFERENCE TO RELATED APPLICATIONS

See Application Data Sheet.

### STATEMENT REGARDING FEDERALLY SPONSORED RESEARCH OR DEVELOPMENT

Not applicable.

### THE NAMES OF PARTIES TO A JOINT RESEARCH AGREEMENT

Not applicable.

### INCORPORATION-BY-REFERENCE OF MATERIAL SUBMITTED ON A COMPACT DISC OR AS A TEXT FILE VIA THE OFFICE ELECTRONIC FILING SYSTEM (EFS-WEB)

Not applicable.

### STATEMENT REGARDING PRIOR DISCLOSURES BY THE INVENTOR OR A JOINT INVENTOR

Not applicable.

### BACKGROUND OF THE INVENTION

1. Field of the Invention

The present invention relates to an assembly for preparing and/or painting large surface areas, such as walls of buildings. The invention can also be adapted for use on floors and ceilings. The invention can also be adapted for other tasks such as installing paneling, screws and bolts use on floors, and ceilings and roofs.

2. Description of Related Art Including Information Disclosed Under 37 CFR 1.97 and 37 CFR 1.98.

Conventional techniques for painting, sanding, preparing or cleaning large surface areas, such as building wall surfaces, require scaffolding or elevated platforms to operate above a single story. Costs and timeframes to use these methods can account for up to 50% of total job costs. For example, scaffolding hire on a job to paint a 14 story apartment block may cost $16,000 and take 2-3 weeks to erect and another 2-3 weeks to tear down. An alternative option is via abseiling, but this is limited to touch up painting due to carrying capacity limits of 2-3 litres.

The present invention seeks to overcome or substantially ameliorate at least some of the deficiencies of the prior art, or to at least provide an alternative.

It is to be understood that, if any prior art information is referred to herein, such reference does not constitute an admission that the information forms part of the common general knowledge in the art, in Australia or any other country.

### BRIEF SUMMARY OF THE INVENTION

According to a first aspect, the present invention provides an assembly for preparing and/or painting a surface of a structure, the assembly comprising:

a movable applicator having a tooltip for preparing and/or painting the surface of the structure; and

mounting means for positioning the movable applicator adjacent the structure and allowing the movable applicator to move along the surface.

In one embodiment, the mounting means comprises left and right side elongate members which are supported to be oriented vertically, horizontally spaced and parallel to each other, the elongate members being cables or poles.

In another embodiment, the elongate members are cables having upper ends and lower ends, the upper ends of the cables being adapted to extend from upper anchor points in the structure, and the lower ends of the cables having tensioning means.

In another embodiment, the movable applicator comprises a frame dimensioned to extend between the elongate members, the frame including left and right side guides for receiving the respective elongate members therethrough, the frame including at least one Y-axis motor for moving the frame in the vertical direction along the length of the elongate members.

In another embodiment, the movable applicator further comprises a carriage movable horizontally along the frame, wherein the carriage carries the tooltip, the movable applicator further comprising an x-axis motor coupled to the carriage for moving the carriage horizontally along the frame.

In another embodiment, the carriage further includes a z-axis motor for moving the tooltip towards or away from the surface.

In another embodiment, the frame further comprises at least one of a spray compressor, a fluid reservoir, battery, a generator, and electronics control.

In another embodiment, the assembly further comprises a camera mounted to the movable applicator and a control system wirelessly connected to the movable applicator, wherein the control system is adapted to scan the surface via the camera to provide a two or three dimensional work map of the surface.

In another embodiment, the assembly further comprises a control system wirelessly connected to the movable applicator, wherein the control system is adapted to take as input a photograph of the surface to be prepared and/or painted and the control system provides a two or three dimensional work map of the surface.

In another embodiment, the control system will automatically plan a path for the movable applicator to cover the work map.

In another embodiment, the mounting means comprises upper and lower horizontal rails, and a vertical member extending between the upper and lower rails, the vertical member having upper and lower ends movable along the upper and lower rails along the x-axis, wherein the movable applicator is movably mounted along the y-axis to the vertical member.

In another embodiment, the mounting means a wheeled carriage having an arm.

In another embodiment, the arm is a robotic arm having a distal end, wherein the movable applicator is mounted to the distal end.

In another embodiment, the arm is a telescopic arm having a distal end, wherein a horizontal track is mounted to the distal end and the movable applicator is movable along the horizontal track.

In another embodiment, the movable applicator is connected via a liquid supply tube to a liquid container mounted on the wheeled carriage.

In another embodiment, the wheeled carriage comprises omnidirectional wheels.

In another aspect, the invention provides an assembly for preparing and/or painting a surface of a structure, the assembly comprising:

a movable applicator having a tooltip for preparing and/or painting a surface of the structure; and mounting means comprising a movable arm for moving the movable applicator along the surface.

Other aspects of the invention are also disclosed.

### BRIEF DESCRIPTION OF THE SEVERAL VIEWS OF THE DRAWINGS

Notwithstanding any other forms which may fall within the scope of the present invention, preferred embodiments of the present invention will now be described, by way of examples only, with reference to the accompanying drawings.

FIG. 1 is a schematic perspective view of an assembly in accordance with a first preferred embodiment of the present invention mounted to a wall.

FIG. 2 is an exploded perspective view of the assembly of FIG. 1.

FIG. 3 is a schematic perspective view of an assembly in accordance with a second preferred embodiment of the present invention mounted to a wall.

FIG. 4 is a schematic perspective view of an assembly in accordance with a third preferred embodiment of the present invention mounted to a wall.

FIG. 5 is a perspective view of an assembly in accordance with a fourth preferred embodiment of the present invention.

FIG. 6 is a perspective view of the assembly of FIG. 5 adapted for another use.

FIG. 7 is a schematic perspective view of an assembly in accordance with a fifth embodiment of the present invention.

### DETAILED DESCRIPTION OF THE INVENTION

It should be noted in the following description that like or the same reference numerals in different embodiments denote the same or similar features.

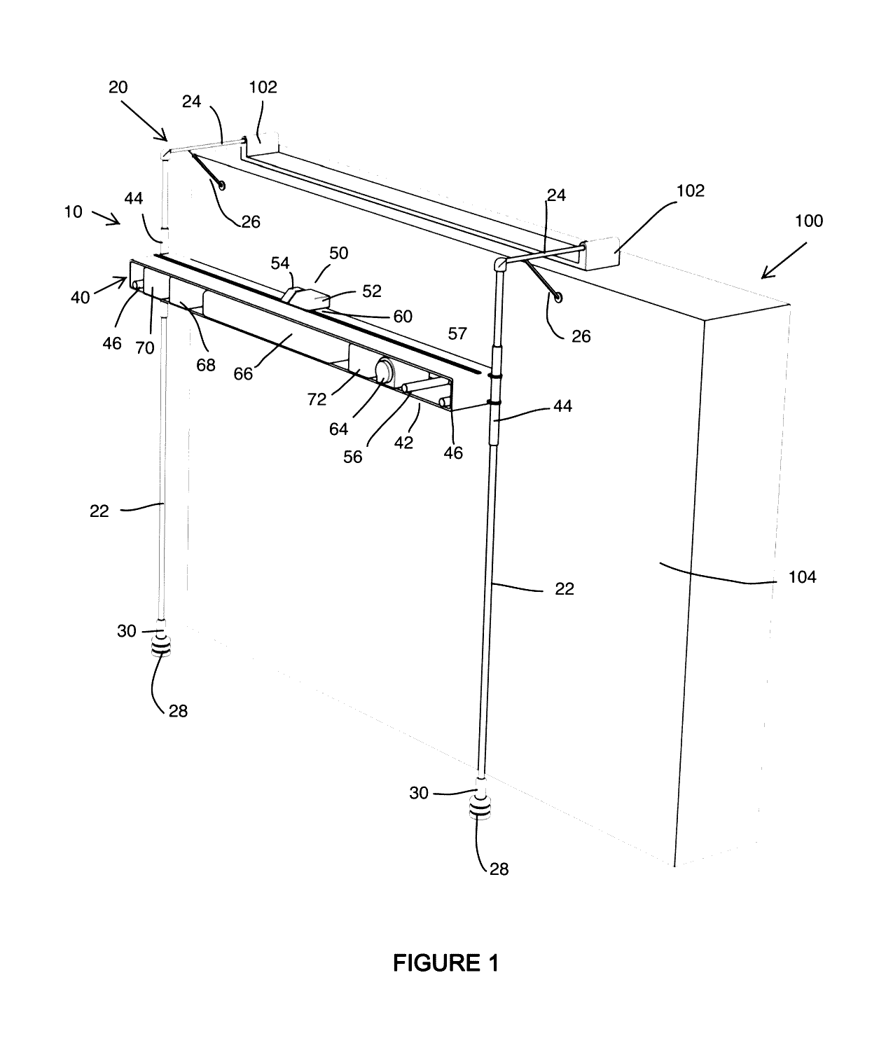

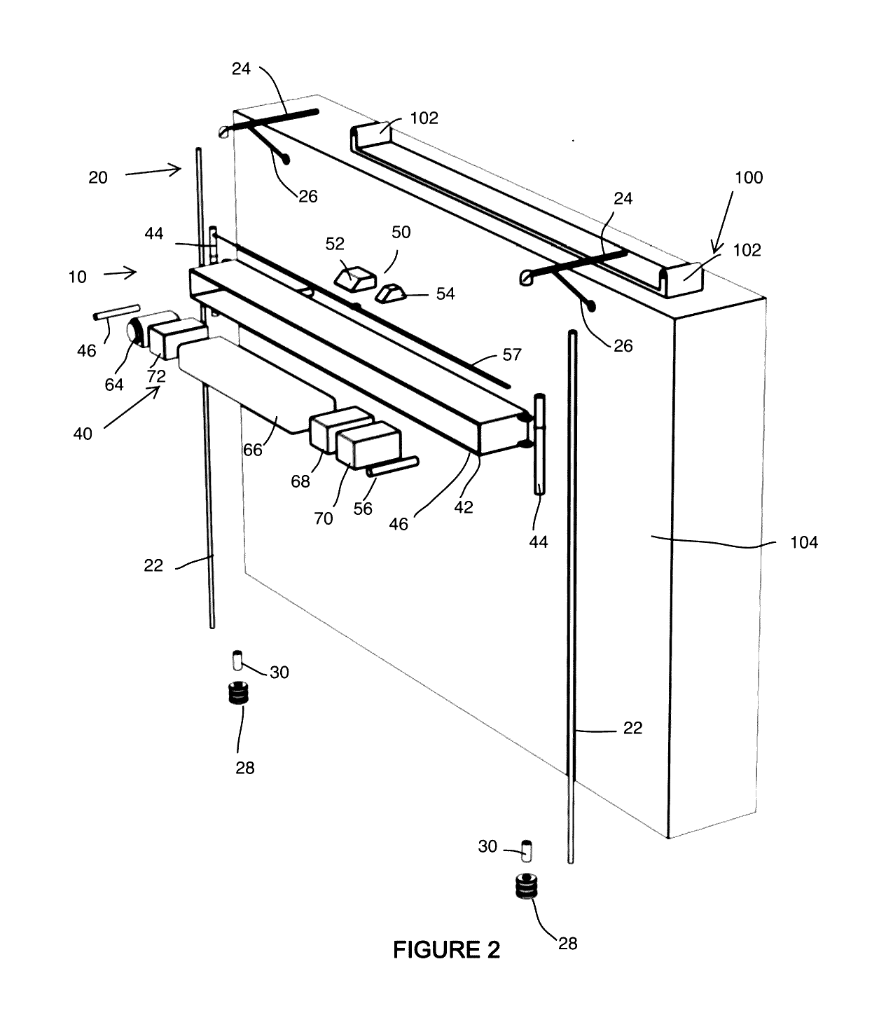

FIGS. 1 and 2 show an assembly 10 for preparing and/or painting large surface areas such as building walls in accordance with a first preferred embodiment of the present invention. The assembly 10 is shown mounted to a wall 100. The assembly 10 preferably uses existing roof anchor points 102 of the wall 100, for preparing and/or painting a large surface 104 of the wall 100.

The assembly 10 comprises mounting means 20 and a movable applicator 40. The mounting means 20 provides a means for positioning the movable applicator 40 adjacent the wall surface 104, and allowing the movable applicator 40 to move along the wall surface 104. In an alternative embodiment described below, the mounting means 20 can move the movable applicator 40 along the wall surface 104.

In the assembly 10, the mounting means 20 comprises left and right side cables 22 which are supported to be oriented vertically, horizontally spaced and parallel to each other. Both cables 22 are spaced from the wall surface 104 by a predetermined distance and are substantially parallel to the wall surface 104. Upper ends of the cables 22 are supported via respective upper bars 24 extending from the anchor points 102, the upper bars 24 being supported by respective brace bars 26. The cables 22 are tensioned at their lower ends by weights 28 and associated tensioning means 30. The cables 22 thus generally form taut rails adjacent the wall surface 104. The movable applicator 40 is the movable along the cables 22 for preparing and/or painting the wall surface 104.

The movable applicator 40 comprises an elongated horizontal frame 42 dimensioned to extend between the cables 22. The frame 42 includes left and right side cable guides 44 for receiving the respective cables 22 therethrough. The cable guides 44 can be tubular or part tubular. The movable applicator 40 includes left and right side Y-axis motors 46 having rotatable traction means, such as rubber wheels or toothed wheels, for engaging the respective left and right side cables 22. The Y-axis motors 46 via the traction means moves the movable applicator 40 in the vertical direction, being along the length of the cables 22.

The movable applicator 40 further comprises a carriage 50 which is movable along the top surface of the frame 42, that is, in the horizontal direction. The carriage 50 comprises a tooltip 52 and a camera 54. An x-axis motor 56 is mounted to the frame 42 and coupled to the carriage 50, for example via a toothed belt 57. The x-axis motor 56 is used for moving the carriage 50 along the x-axis that is, being horizontally along the length of the frame 42, along an x-axis parallel to the wall surface 104.

The carriage 50 further includes a z-axis motor 60 which is used for moving the tooltip 52 and the camera 54 towards or away from the wall surface 104. The z-axis motor 60 for example can be used to move the whole carriage 50, or for moving the tooltip 52 and camera 54 only, along an axis perpendicular to the wall surface 104.

The tooltip 52 and camera 54 are thus movable along the x, y and z axes relative to the wall surface 104. The tooltip 52 and camera 54 can service an operating area between the cables 22 and between the upper and lower ends of the cables 22.

The frame 42 additionally carries an airless spray compressor 64, a fluid reservoir 66, battery 68, a generator 70, and electronics control 72. The compressor 64 is for supplying liquid carried in the reservoir 66 to the tooltip 52. The compressor 64, electronics control 72 and the motors 46, 56 and 60 are powered by the battery 68 which is recharged as needed by the generator 70. The electronics control 72 controls the motors 46, 56 and 60 to move the frame 42 and carriage 50 as required for positioning and moving the tooltip 52 and the camera 54. The electronics control 72 also controls the generator 70 and the compressor 64 for providing liquids to the tooltip 52.

The assembly 10 is fixed securely adjacent to surfaces to be painted. The assembly 10 will be compatible with existing standard anchor points systems currently used. Where no suitable anchor points exist, the mounting means 20 can comprise anchors for securely attaching to buildings.

In the embodiment, the carriage 50 is capable of horizontal tool speed rates of between 0.01 and 1 m/s, and the movable applicator 40 is capable of vertical tool rates of between 0.01 and 0.3 m/s. The electronics control 72 will actively level the frame 42 to remain horizontal, and the movable applicator 40 can additionally comprise accelerometers for determining its orientation.

A control system for the movable applicator 40 is provided with commands passed wirelessly to the electronics control 72. A user interface is provided via a laptop computer, smartphone, tablet, game controller or dedicated console, by which the operator can view generated commands to the control system and modify the commands as needed.

The control system will initially scan the operating area via the camera 54, which is the area of the wall surface 104 within range of the tooltip 52. The control system will then provide the user an image of the scanned operating area in two or three dimensions visually representing the surface to be operated on. The control system will also detect areas it considers should not be operated on including windows. This results in a work surface map, being the operating surface area without the excluded areas. Scanning is preferably in three dimensions to allow z axis movement toward and away from the wall 100, and also to allow the tooltip 52 to adopt appropriate direction/orientation for working on surfaces not parallel or contiguous with the main surface of the wall 100.

The control system can also be adapted to take as input a photograph of the wall to be prepared and/or painted. The photograph can be taken from the user interface or uploaded thereto, and the control system will then transform the image and account for ground perspective angle, and use the image as a basis for the operating surface area.

The control system will allow a user to edit the generated work surface map by moving, resizing, skewing, or creating polygons which can be added or removed from the operating area via the user interface.

The control system will then generate an operation plan for the work surface map, and to save the operation plan for later retrieval and use, for example to facilitate multiple passes or coats with other operations in between.

The control system will automatically plan a path to cover the planned work surface area. The control system will automatically move the tooltip in the horizontal and vertical planes to cover the operation plan in accordance with the planned path.

The user can manually override any of the planned automatic movement of the movable applicator 40 via the user interface. The control system will allow a user to cancel any planned operation. The control system will also allow a user to manually move the tool up, down, left, right, toward, or away from the work surface and to turn the tool on or off via the user interface.

The camera 54 can also be used for viewing and monitoring the wall surface 104, in addition to scanning the wall surface 104. The camera 54 can also be used for calculating the amount of liquid (e.g. paint) needed for application of a coating. Other sensors can also be used, such as an ultrasonic sensor or LIDAR to determine distance, shapes, texture and other parameters.

The assembly will plan and execute paths covering large surfaces such as the sides of small buildings greater than 2 stories. Other embodiments will plan and execute paths covering large surfaces such as the sides of large buildings greater than 20 stories

In a main use, the movable applicator 40 is used for painting the wall surface 104. The tooltip 52 will include a spray painting nozzle with paint being supplied from the reservoir 66 by the compressor 64. The assembly in one embodiment will carry or access sufficient paint to cover 40 square meters without stopping to refill. In another embodiment, the assembly 10 will carry or access sufficient paint to cover 100 square meters without stopping to refill

The control system will automatically control fluid pressure via the compressor 64, and turn the compressor 64 off and on as required to cover the work surface area and prevent coverage of non-operating areas. The control system will ensure even coverage of fluids by controlling motion of the tool relative to the flow of fluid. The control system will be user configurable via the user interface to various application rates and thicknesses.

The assembly 10 provides a substantially constant tool orientation and distance from the work surface, being the wall surface 104. The assembly 10 also provides a stable tool orientation relative to the work surface in general operation. The assembly 10 will allow orientation of the tool 52 to be adjusted remotely, via a remote control, for example to paint, clean under and on top of window ledges. The tooltip can be mounted to a robotic arm to provide the required orientation for surfaces not parallel to the main surface of the wall 100.

In another embodiment, the movable applicator 40 comprises different interchangeable tools for performing multiple tasks apart from spray painting, including sanding, rendering, pressure washing and window washing. A sanding attachment can be used to remove paint to an even depth, and the assembly preferably includes means to collect sanded dust.

The assembly can also use a pressure washing attachment to clean surfaces, which is adjustable by the user to suit surfaces via the user interface. The assembly can also include a water and squeegee attachment to clean windows

In the preferred embodiment, the movable applicator 40 control system includes at least thirty factory presets for different common tasks, which the user can edit if needed. These tasks and present parameters can include: horizontal tooltip rate, vertical tooltip rate, paint application rate, paint coat thickness, coat overlap in mm and nozzle spread.

The system will automatically calculate and perform horizontal and vertical movements required to achieve the desired paint coat thickness based on the installed nozzle and paint type.

The control system can also notify the user of warning or status conditions including the following: fluid (paint, water, cleaning solution) low, fluid (paint, water, cleaning solution) empty, obstacles detected, possible obstacle collision, unexpected fluid pressure - high/low that may indicate blockage or leak. The warnings can trigger an alarm which can be audible and visible via the user interface with a description of the issue and recommended action to resolve. The alarm is preferably clearly audible from 100 m away. The system can also be adapted to cease operation pending input from the user in the event of an error or warning including obstacle collision, unable to maintain horizontal surface of beam, unable to maintain desired tooltip distance or any of the above warnings.

The control system will connect wirelessly to the user interface running supported operating system on a supported device preferably up to 200 m away. The system will stream a live view of the tooltip 52 from the camera 54 located near the tooltip 52 to the user via the user interface.

The assembly 10 in use thus works by attaching cables 22 to a building, which support a robotic platform (the movable applicator 40), which automatically actuates interchangeable tools over the wall of the building to perform sanding, washing or painting of surfaces.

The tool 52 is moved as needed to prepare or paint the wall surface 104. The reservoir 66 is replenished as needed, for example with the movable applicator 40 returning to ground, roof or convenient level for an operator to refill the reservoir 66. The electronics control 72 will remember and return the movable applicator 40 to the last position. Alternatively, the tool 52 can be connected via a hose to a long liquid supply tube connected to a large liquid container at ground, roof or convenient level. This can avoid having the need to replenish the reservoir 66.

The assembly will also be adjustable, scalable and/or configurable to cover heights up to several hundred meters, and widths as small as 2 metres and as wide as 10 meters.

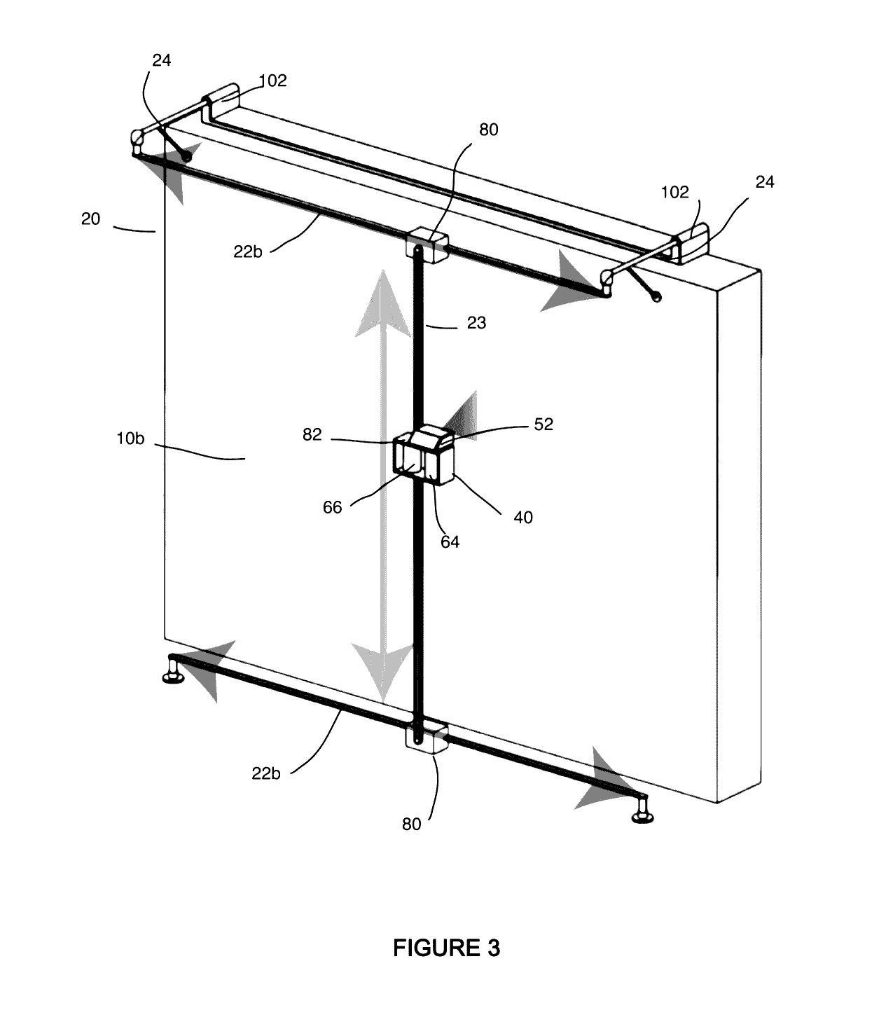

FIG. 3 shows a second preferred embodiment of an assembly 10b mounted to a wall. The assembly 10b is similar to the assembly 10 above. The assembly 10b also comprises mounting means 20 and a movable applicator 40.

In the assembly 10b, the mounting means 20b comprises upper and lower rails 22b which are supported to be oriented horizontal, vertically spaced and parallel to each other. The upper rail 22b is supported via the upper bars 24 extending from the anchor points 102. The lower rail 22b is supported along and spaced from the ground.

The mounting means 20b additionally includes a vertical member 23 extending between the upper and lower rails 22b. The vertical member 23 can be a cable, chain, loop or belt. Upper and lower ends of the vertical member 23 are provided with respective motors 80 for moving along the upper and lower rails 22b. The motors 80 thus provide x-axis movement of the movable applicator 40.

The movable applicator 40 comprises a smaller rectangular frame 42 having a Y-axis motors 82 for engaging the vertical member 23. The Y-axis motor 82 thus moves the movable applicator 40 in the vertical direction.

The frame 42 carries the tooltip 52, airless spray compressor 64, and the fluid reservoir 66. This embodiment for example can be used for painting the wall surface 104 via remote control using the user interface. Alternatively, the frame 42 can additionally include the camera and control means for automatic painting. The tool 52 can alternatively be connected via a hose to a long liquid supply tube connected to a large liquid container at ground, roof or convenient level.

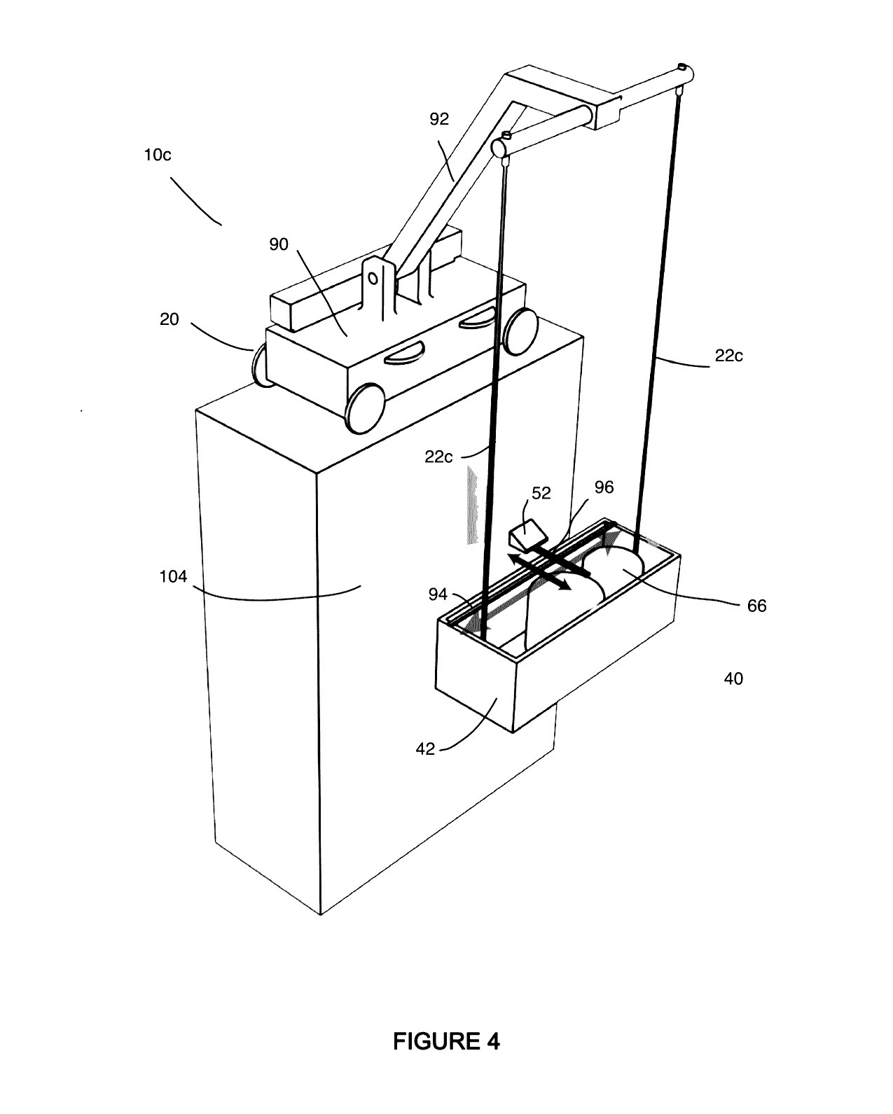

FIG. 4 shows a third preferred embodiment of an assembly 10c. The assembly 10c also comprises mounting means 20 and a movable applicator 40.

In the assembly 10c, the mounting means 20c comprises a swing stage 90 having an arm 92 extending over the wall surface 104. The arm 92 carries first and second vertical side cables 22c. The movable applicator 40 is provided with respective motors for moving along the cables 22c. These motors thus provide y-axis movement of the movable applicator 40.

The movable applicator 40 comprises a large swing stage cradle 42 having an x-axis track 94 and to which is mounted the tooltip 52. The tooltip 52 additionally includes a z-axis track 96. Respective motors provide the x-axis and z-axis movements of the tooltip 52.

The cradle 42 can carry larger fluid reservoirs 66. This embodiment for example can also be used for painting, washing or cleaning the wall surface 104 via remote control using the user interface. Alternatively, the cradle 42 can additionally include the camera and control means for automatic operation. The swing stage 90 can also be moved along the wall which will allow quick relocation of the assembly 10c.

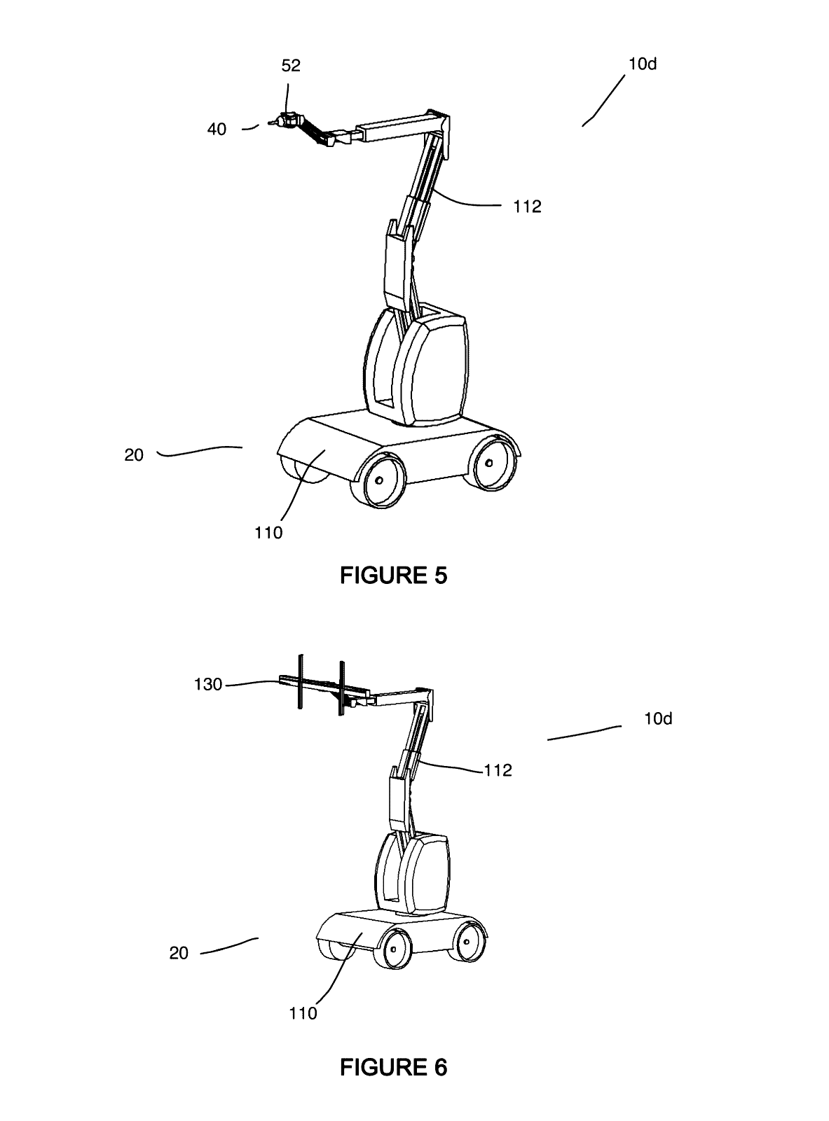

FIG. 5 shows a fourth preferred embodiment of an assembly 10d. The assembly 10d also comprises mounting means 20 and a movable applicator 40.

In the assembly 10d, the mounting means 20d comprises a wheeled carriage 110 having a robotic arm 112. The robotic arm 112 carries the movable applicator 40 at its tip. The robotic arm 112 provides the x-axis, y-axis movement and z-axis movement of the movable applicator 40 which has the tooltip 52.

As shown in FIG. 6, the assembly 10d can be adapted for other uses. The movable applicator 40 can be replaced with mounts 130 for grabbing items such as solar panels, roofing sheets and the like, and affix them to a structure using fasteners (e.g. bolts, screws or nails) it can administer with a tool (e.g. a drill or gun).

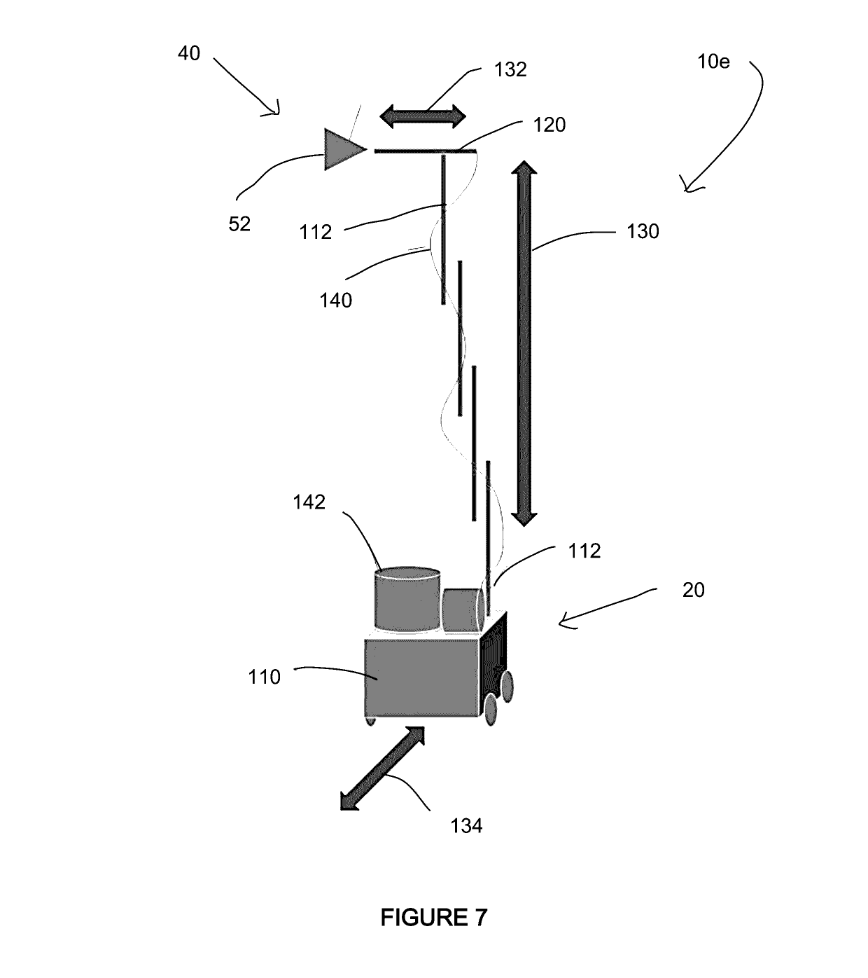

FIG. 7 shows a fifth preferred embodiment of an assembly 10e. The assembly 10e also comprises a mounting means 20 and a movable applicator 40.

In the assembly 10e, the mounting means 20d comprises a wheeled carriage 110 having a telescoping arm 112. The top end of the telescoping arm 112 includes a horizontal track 120 onto which the movable applicator 40 is movably mounted, which allows for the x-axis 132 movement thereof. The telescoping arm 112 can also rotate along its axis which will pivot the horizontal track 120 about the vertical axis if needed. The telescoping arm 112 provides the y-axis 130 movement of the movable applicator 40 which has the tooltip 52 and provides variable and longer height coverage.

The tooltip 52 is connected via a long liquid supply tube 140 to a large liquid container 142 on the wheeled carriage 110. The wheeled carriage 110 provides the z-axis 134 movement. The wheeled carriage 110 can also include omnidirectional wheels to allow the carriage 110 to move along any combination of the x-axis and z-axis directions.

The present invention thus provides an assembly for preparing and/or painting large area surfaces with a substantial number of advantages.

The preferred embodiment allows the operator to reduce equipment and labour costs, reduce work time, and increase safety of work on buildings at height through automation. Significant savings can be made through the use of an automated unmanned robot to perform these tasks. Benefits include:

Reducing or eliminating need for humans to work at heights to undertake these tasks

Reducing or eliminating safety risks and associated liability or insurance costs

Reducing or eliminating the need to hire equipment required for humans to access heights

Reducing or eliminating the need for specialised skills - equipment operators or abseilers

Reducing wastage of products such as paint

Improving quality of application

Eliminating time taken to transport, setup and teardown access equipment

Reducing or eliminating external dependencies e.g. on access hire companies

Reduce or eliminate disturbance & obstruction to occupants of building during work

Whilst preferred embodiments of the present invention have been described, it will be apparent to skilled persons that modifications can be made to the embodiments described. The mounting means for example can be adapted for painting floors or ceilings if needed. The cable can be replaced by stiffer metal rails. The cables can also be replaced by vertical posts or telescopic posts.

1. An assembly for preparing and/or painting a surface of a structure, the assembly comprising:
a movable applicator having a tooltip for the surface of the structure; and
mounting means for said movable applicator, said movable applicator being adjacent the structure and movable along the surface.

2. The assembly of claim 1, wherein the mounting means comprises left and right side elongate members being supported to be oriented vertically, horizontally spaced and parallel to each other, the elongate members being comprised of at least one of a group consisting of: cables and poles.

3. The assembly of claim 2, wherein the elongate members are cables, each cable having an upper ends and a lower end, wherein each upper end extends from upper anchor points in the structure, and wherein each lower end comprises a respective tensioning means.

4. The assembly of claim 2, wherein the movable applicator comprises a frame extending between the elongate members,
wherein the frame comprises: left and right side guides, the guides receiving respective elongate members therethrough; and at least one Y-axis motor for moving the frame in the vertical direction along a length of the elongate members.

5. The assembly of claim 4, wherein the movable applicator further comprises:
a carriage movable horizontally along the frame, wherein the carriage carries the tooltip; and
an x-axis motor coupled to the carriage for moving the carriage horizontally along the frame.

6. The assembly of claim 5, wherein the carriage further comprises a z-axis motor for moving the tooltip relative to the surface.

7. The assembly of claim 6, wherein the frame further comprises at least one of a group consisting of: a spray compressor, a fluid reservoir, battery, a generator, and electronics control.

8. The assembly of claim 1, further comprising:
a camera mounted to the movable applicator; and
a control system wirelessly connected to the movable applicator,
wherein the control system scans the surface via the camera to provide a two or three dimensional work map of the surface.

9. The assembly of claim 1, further comprising:
a control system wirelessly connected to the movable applicator,
wherein the control system takes as input a photograph of the surface, and
wherein the control system provides a two or three dimensional work map of the surface.

10. The assembly of claim 8, wherein the control system has a path automatically planned for the movable applicator to cover the work map.

11. The assembly of claim 1, wherein the mounting means comprises upper and lower horizontal rails, and a vertical member extending between the upper and lower rails, the vertical member having an upper end and a lower end, the ends being movable along the upper and lower rails along an x-axis, wherein the movable applicator is movably mounted along a y-axis to the vertical member.

12. The assembly of claim 1, wherein the mounting means is comprised of a wheeled carriage having an arm.

13. The assembly of claim 12, wherein the arm is comprised of a robotic arm having a distal end, and wherein the movable applicator is mounted to the distal end.

14. The assembly of claim 12, wherein the arm is comprised of a telescopic arm having a distal end, wherein a horizontal track is mounted to the distal end and the movable applicator is movable along the horizontal track.

15. The assembly of claim 14, wherein the movable applicator is connected via a liquid supply tube to a liquid container mounted on the wheeled carriage.

16. The assembly of claim 15, wherein the wheeled carriage comprises omnidirectional wheels.

17. An assembly for preparing and/or painting a surface of a structure, the assembly comprising:
a movable applicator having a tooltip for a surface of the structure; and
mounting means being comprised of a movable arm connected to said movable applicator so as to move the movable applicator along the surface.
